(19) United States
(12) Patent Application Publication
(10) Pub. No.: US 2025/0274499 A1
(43) Pub. Date: Aug. 28, 2025

(54) CDN OFFLOAD VIA HYBRID DELIVERY OVER ATSC 3.0 FOR LIVE VIDEO STREAMING

(71) Applicant: One Media, LLC, Cockeysville, MD (US)

(72) Inventor: Liam Riley POWER, New Freedom, PA (US)

(73) Assignee: One Media, LLC, Cockeysville, MD (US)

(21) Appl. No.: 18/902,313

(22) Filed: Sep. 30, 2024

Related U.S. Application Data
(60) Provisional application No. 63/558,571, filed on Feb. 27, 2024.

(51) Int. Cl. H04L 65/752; H04L 65/80; H04N 21/2662; H04N 21/426

(52) U.S. Cl. CPC H04L 65/752; H04L 65/80; H04N 21/2662; H04N 21/4263

(57) ABSTRACT

One of the promises of ATSC 3.0 has been the potential for data offload. Separately, advances have been made in hybrid and IP channel rollouts on ATSC 3.0 over the last year. The two have been combined to architect and implement a data offload system. This application explores a practical hybrid delivery model for streaming video services, allowing the distribution of video over CDNs and simultaneously over 3.0, drastically decreasing the bandwidth needs of these CDNs in 3.0 markets, all while integrating into third-party streaming apps to enable seamless streaming with no change to the viewer experience. Topics covered include the methodology for synchronization, encoding needs for the CDN and airchain, signaling design, integration into a streaming application, and the results of the real-world testing of this system.

### CROSS REFERENCE TO RELATED APPLICATIONS

This application claims the benefit of U.S. Provisional Application No. 63/558,571 filed Feb. 27, 2024, titled “CDN OFFLOAD VIA HYBRID DELIVERY OVER ATSC 3.0 FOR LIVE VIDEO STREAMING,” the content of which is herein incorporated by reference in its entirety.

### BACKGROUND

The described aspects generally relate to video streaming.

### SUMMARY

Some aspects of this disclosure relate to systems, apparatuses, and methods for hybrid delivery of live video streaming. For example, the systems, the apparatuses, and the methods are provided for offloading video segments from content delivery networks (CDNs) to advanced television systems committee (ATSC) 3.0 streaming.

Some aspects of this disclosure relate to a method. The method includes receiving, at a media client device, an over the air (OTA) MPD over an OTT communications channel. The OTA MPD corresponds to a plurality of OTA media segments and a plurality of OTT media segments. The OTA media segments and the OTT media segments correspond to a same time period of a media program. The method further includes extracting, from the OTA MPD, an identifier corresponding to an OTA communications channel and tuning a receiver to the OTA communication channel. The method further includes receiving, using the receiver, one or more OTA media segments of the plurality of OTA media segments over the OTA communications channel and switching from playing a representation of the media program from one or more OTT segments of the plurality of OTT segments to playing another representation of the media program from the one or more OTA media segments of the plurality of OTA media segments. In some embodiments, the OTT MPD, the OTT media segments, and the OTT communication channel can also be MPD describing transmission over the Internet, media segments transmitted via the Internet, and Internet communication channel, respectively.

Some aspects of this disclosure relate to a system including a memory and at least one processor coupled to the memory. The at least one processor is configured to receive, at a media client device, an over the air (OTA) MPD over an OTT communications channel. The OTA MPD corresponds to a plurality of OTA media segments and a plurality of OTT media segments. The OTA media segments and the OTT media segments correspond to a same time period of a media program. The at least one processor is further configured to extract, from the OTA MPD, an identifier corresponding to an OTA communications channel and tune a receiver to the OTA communication channel. The at least one processor is further configured to receive, using the receiver, one or more OTA media segments of the plurality of OTA media segments over the OTA communications channel and switch from playing a representation of the media program from one or more OTT segments of the plurality of OTT segments to playing another representation of the media program from the one or more OTA media segments of the plurality of OTA media segments.

Some aspects of this disclosure relate to a method. The method includes transmitting a provisioning request to a broadcast provisioning platform and receiving an identifier corresponding to an over the air (OTA) communications channel from the broadcast provisioning platform. The method further includes encoding the identifier corresponding to the OTA communications channel in an OTA media presentation description (MPD) and transmitting, to a media client device, an over the top (OTT) MPD and the OTA MPD over an OTT communications channel. The OTT MPD corresponds to a plurality of OTT media segments and the OTA MPD corresponds to a plurality of OTA media segments. The OTA media segments and the OTT media segments correspond to a same time period of a media program. The method further includes transmitting the plurality of OTA media segments to an Advanced Television Systems Committee (ATSC) 3.0 broadcast node, or other broadcast nodes, and transmitting, to the media client device, one or more OTT media segments of the plurality of OTT segments over the OTT communications channel.

Some aspects of this disclosure relate to a system including a memory and at least one processor coupled to the memory. The at least one processor is configured to transmit a provisioning request to a broadcast provisioning platform and receive an identifier corresponding to an over the air (OTA) communications channel from the broadcast provisioning platform. The at least one processor is further configured to encode the identifier corresponding to the OTA communications channel in an OTA media presentation description (MPD) and transmit, to a media client device, the OTA MPD over an OTT communications channel. The OTA MPD corresponds to a plurality of OTA media segments and a plurality of OTT media segments. The OTA media segments and the OTT media segments correspond to a same time period of a media program. The at least one processor is further configured to transmit the plurality of OTA segments to a broadcast node and transmit, to the media client device, one or more OTT segments of the plurality of OTT segments over the OTT communications channel. The media client switches from playing the media program from one or more OTT segments of the plurality of OTT segments to playing the media program from the one or more OTA media segments of the plurality of OTA media segments.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates global Internet traffic by year, according to aspects of the disclosure.

FIG. 2 illustrates an exemplary system design for offload, showing the MPD and segment retrieval for each transport, according to aspects of the disclosure.

FIG. 3 illustrates an exemplary workflow for provisioning an offload service from a CDN to a broadcaster, according to aspects of the disclosure.

FIG. 4 illustrates an exemplary sequence of video playback, according to aspects of the disclosure.

FIG. 5 illustrates an exemplary generalized CDN architecture, according to aspects of the disclosure.

FIG. 6 illustrates an exemplary demo configuration for the Seattle proof of concept, according to aspects of the disclosure.

FIG. 7 is an example computer system for implementing some aspects of the disclosure or portion(s) thereof, according to aspects of the disclosure.

FIG. 8 illustrates an exemplary method of offloading media segments, according to aspects of the disclosure.

FIG. 9 illustrates an exemplary method of transmitting media segments, according to aspects of the disclosure.

FIG. 10 illustrates an exemplary method of switching between OTT segments and OTA segment while playing content, according to aspects of the disclosure.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Introduction

As broadband video streaming has increased over the past decade, so has the bandwidth need. This presents a problem that may be solved by applying technologies in the ATSC 3.0 standard. Modern streaming services often utilize dynamic adaptive streaming over hypertext transfer protocol (HTTP) (DASH) for their delivery, which provides a convergence point with ATSC 3.0 that has DASH over real-time object delivery over unidirectional transport (ROUTE) as one of two options for video transport, the other being moving picture experts group (MPEG) multimedia transport (MMT) payload (MMTP). To ease the substantial burden on the content distribution system writ large, broadcasters may design a system to send the same segments being encoded for the broadband-delivered OTT service over the air instead, delivered to the receiver with no change compared to what may arrive had they been sent over the internet. In turn, the receiver may treat the DASH segments as just another representation in the DASH ladder, seamlessly moving up and down depending on reception quality. While technically impressive, it also significantly benefits delivery efficiency, drastically reducing CDN load for the stream.

This idea led to a set of objectives;
Offload: The system provides substantial improvement over traditional broadband delivery for traffic usage.
Seamless: The system does not negatively impact the viewer's experience.
Low Impact: The system does not require dramatic modification of the streamer's DASH workflow.
Multi-Market: The system handles distribution across multiple markets to maximize offload.

Naturally, improving technology comes with new challenges, and so this application seeks to examine the various issues encountered and how they were dealt with while providing context and plans for this development:
Section 1 describes the problem with the current streaming infrastructure.
Section 2 notes some related work to address these issues.
Section 3 outlines the design of the overall system.
Section 4 illustrates a variety of challenges encountered in the process.
Section 5 covers the real-world demonstration conducted to prove out the system.

### Section 1: The Broadband Problem

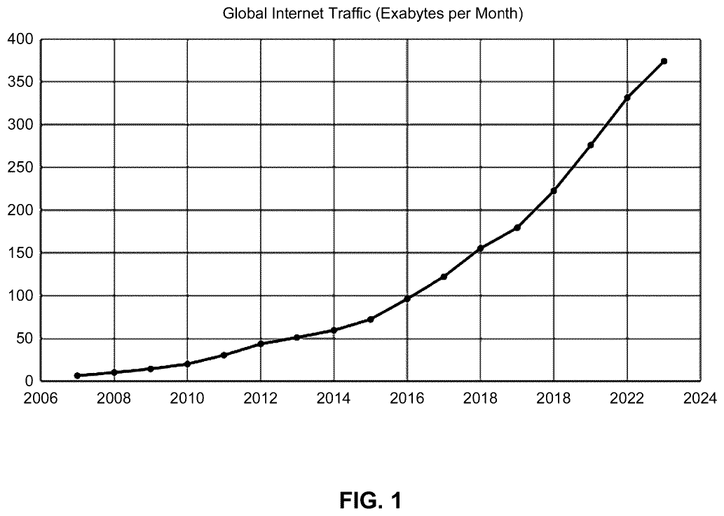

As more and more households start to use streaming services, with around 90% of households using at least one Subscription Video On Demand (SVOD) service, and others using free ad-supported services like YouTube™, (free ad-supported streaming TV) FAST channels, or Advertising Video On Demand (AVOD), streaming video bandwidth usage has correspondingly increased. In 2022, over 65% of internet traffic was purely streaming video, with projections that video may reach over 80% shortly. Netflix™ alone uses 15% of internet bandwidth worldwide. Internet service providers (ISPs) have consequently had to adjust their infrastructure to adapt to this drastic increase in traffic, a nearly 60x increase since 2007 when the iPhone was unveiled and Netflix™ launched their streaming service. Current estimates are that that rate may continue to increase at 25% per year. FIG. 1 illustrates the increase in average monthly internet traffic by year.

The data usage has also impacted the streaming services. Video streaming has a tremendous infrastructure cost, forcing compromises and mitigations. On the mitigation side, there are efforts like Netflix™'s Open Connect project. This is a system whereby Netflix™ has distributed caching servers to thousands of ISP headends in almost every country on the planet at the cost of about $1 billion. This allows them to store their VOD content locally at the ISP, serving it to the ISP's customers from inside the network instead of requiring the ISP to transfer the traffic from Netflix™'s data centers across a Tier 1 or Tier 2 network. While this is an ingenious solution for VOD with a noticeable impact on their distribution costs, it still puts them substantially above the equivalent cost for broadcast and incurs serious delay issues for live events. It also adds complexity to the delivery apparatus compared to broadcast, causing issues such as the “Love is Blind” live reunion fiasco in 2023 due to technical bugs (hour-long delays caused by an overwhelmed distribution infrastructure). In a notable example of the impact of this cost, the live streaming company, Twitch™, recently pulled out of the South Korean market due to the high costs incurred from the ‘sender-party-pays’ model of bandwidth usage required in the country. This same model has been pitched in the EU and US, and could further drive up costs if implemented.

Meanwhile, compromises abound for broadband-one-to-one-video delivery. Every extra bit delivered over broadband is multiplied by the number of viewers, so there is a solid incentive to compress the bitrates as much as possible. This is what results in situations like the commonly used 10-15 mbps for high efficiency video coding (HEVC) 4 k streaming, which presents quite a poor picture quality for all the hype around 4 k. For reference, 10 mbps is what is used as the rule of thumb for the 720 p/1080 i mpeg2 broadcasts on the primary streams of stations, while 4K Blu-rays operate around 72-144 mbps HEVC. A well-known example of this is the Game of Thrones episode “The Long Night.” This was an event viewed live by millions of people from one of the most popular shows of the time, so any increase in bitrate may have incurred a significant increase in distribution charges. Unfortunately, this was not an ideal episode for the highly compressed HBO™ streaming services, featuring very dark scenes and plenty of high-motion action. A low-bitrate video with 8-bit (non-HDR) color may suffer under these circumstances, and it suffered indeed. The telecast led to a remarkable number of complaints regarding the viewability of the episode, as many viewers were unable to discern the detail in the blotchy pictures. While HBO™ does not officially disclose these numbers, viewers reported a video bitrate of 3-5 mbps. Even in the current ATSC 3.0 deployment scenario where 3.0 transmitters are forced to host all the main channels simultaneously, each program stream is targeted at bitrates higher than 3 mbps because stations do not have the same concerns.

Projections for profit margins on streaming services remain well below the current margins of broadcast and cable-delivered services. In fact, almost every major streaming service other than Netflix™ is not even profitable at present. Using Netflix™ as an example, which likely has some of the lowest content delivery network (CDN) costs due to its immense internal buildout efforts, the service spends an estimated $4 per user on non-content non-marketing costs like CDNs and technology. When compared to the cost incurred for distribution via broadcast and cable, it is quite the leap. Most other streaming services use third-party CDNs like Amazon Web Services (AWS)™, which costs significantly more. Comcast's Peacock service, for example, consumed about 30 percent of U.S. internet traffic to supply the video to its 23 million viewers for the Peacock-exclusive Chiefs-Dolphins NFL™M playoff game this year. Assuming 5 mbps per viewer, watching for 3 hours each, that would be nearly $8 million in data transfer costs on Amazon™'s S3. Naturally, not everyone watched for 3 hours, and NBC™ presumably has a lower negotiated rate, but it provides a rough ballpark on the distribution costs for a single live event with fewer viewers than an equivalent event has on broadcast.

To highlight the efficiency disparity between one-to-one vs. one-to-many more directly, there are about 300 million cell phones in America and another 150 million tablets/laptops. If you wanted to stream the Oppenheimer movie to all those devices, for example, it may require about 1 GB of data per device. That's 450 Million GB of data for the 1-to-1 delivery to all those devices. Contrast that with the over-the-air broadcast system that serves 210 Nielsen markets in the country, where only 210 GB would be needed to serve the same territory. That's like turning a 30 MPG car into one getting 64 Million MPG-with the ability to drive around the globe 2,600 times. That's efficiency.

All this is to say that the fundamental design of broadband presents significant issues for efficient live video delivery, as a unicast delivery model with each viewer may need a separate stream cannot match the efficiency of a broadcast model where each viewer utilizes the same stream. How, then, other technologies can be leveraged to address this inadequacy?

### Section 2: Related Solutions

As a preface to a discussion on solutions, it is worth noting the development of a couple of separate but related systems utilized today.

From the broadband side, BBC™ R&D have been developing multicast video delivery over broadband via quick user datagram protocol (UDP) Internet connections (QUIC). This mitigates some of the above-noted issues and allow for a less hardware-intensive system of caches everywhere. It does, however, rely on the support of ISPs along the chain for full efficiency and needs quite a lot of standards work for full implementation.

Meanwhile, (Internet protocol) IP channels have been growing in usage on the broadcast side, stemming from their first demonstration by Harmonic™, Sony™, and Weigel Broadcasting™ in 2019. These are channels signaled in the broadcast but with the segments delivered over broadband and potentially broadcast. Some prominent examples are WPBT in Miami, KVVU in Las Vegas, and T2 across Sinclair-operated stations. Reading this, it may be unusual to highlight that a move to broadband instead of broadcast is considered. However, this is significant for two reasons.

First, this represents an example of mixing the broadband and broadcast. It does not have the same issues, methods, or benefits as the solution described herein, but it nevertheless opens the gates to the idea. The above can be considered a ‘broadcast-first’ model, where discovery is conducted on the broadcast signal, after which content is retrieved from broadband. The demonstration in 2019 used the hybrid model, in which broadband was used to provide higher quality video, start over, trick mode, and faster channel change times, while the broadcast was provided as a fallback if broadband was unavailable.

Since then, production deployments have utilized IP—“Virtual”—channels in a broadband model, with the signaling delivered via broadcast and all segments delivered via broadband. This requires the viewer to have internet access but frees up spectrum resources, allowing additional services like diginets without taking up valuable spectrum. The previous is especially important during this transition period when each market generally only has a single 3.0 transmitter due to the simulcasting requirements [9], which is normally enough to house the primary services of each station and not much else.

The latter also brings up the idea of spectrum prioritization. Spectrum is a finite resource, and so it makes sense to prioritize based on efficiency. A high viewership program should naturally be delivered via broadcast, while a low viewership program makes sense to deliver via broadband when higher viewership programs are in progress. Ignoring the business element, it's fundamentally a question of optimization, with the best tool being used for each job.

### Section 3: System Design

One of the most significant advantages of ATSC 3.0 is its IP-based nature, with transport methods designed to work in a modern environment with multiple communication routes. This permits program distributors to engage in a dual path design where some segments are carried over broadcast while others are carried over broadband. ROUTE is fundamentally another transport medium equivalent to HTTP, and DASH segments are just files carried over that transport medium. The nitty gritty details are more complex of course, but the fundamental design is based around that equivalency. This implementation thus allows us to carry video over broadcast transparently and merge it with the media carried via broadband on the receiver side, allowing for a dramatically reduced CDN load, as the heaviest representation may be carried over a one-to-all delivery mechanism, which has just as much effort to send to one viewer as it does to one million viewers. A factor is the ability to do that seamless delivery, which is explored here.

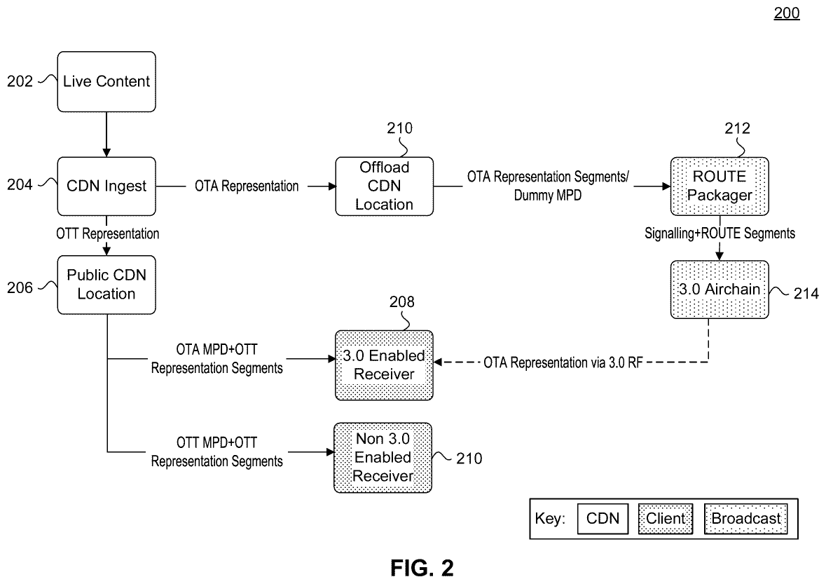

FIG. 2 illustrates an exemplary system design for offload, showing the MPD and segment retrieval for each transport, according to some aspects.

FIG. 2 outlines the general system. In this system, an initial stream is ingested into CDN 204 from live content 202. The tested CDN 204 performed its ladder encode as part of the ingest process, but this may also be done prior without any impact on the result. In either scenario, the CDN 204 may transmit one or more OTA representations to an offload CDN location 210. The result is that the CDN 204 ends up with the segments for each representation. It then may generate the corresponding MPD. This system utilizes three MPDs, which will be explained in detail below.

The chosen representation(s) are ingested into an airchain, such as a 3.0 airchain 214 using the dummy MPD, which allows the packager, such as a ROUTE packager 212, to easily pull down the segments generated with minimal workflow modification on the CDN 204 or the packager. According to some aspects, the packager herein refers to the device responsible for the generation of the Low Level Signaling and Service Layer Signaling, along with ROUTE and/or MMTP transport streams. The packager then bundles these segments into the ROUTE transport stream, along with the appropriate signaling, described later. This results in a ROUTE multicast stream with the appropriate signaling ready for transmission over the air, which may be sent on a 3.0 signal as standard, at which point it is ready for reception by a 3.0-enabled device 208.

When the viewer decides to watch the stream, the OTT process begins as normal, with the client reaching out to the streaming location to retrieve the MPD. As part of that request, however, it signals that it is a 3.0-enabled device, in the case of our proof of concept (PoC) via query flags. Once it has done so, the server then responds with the MPD, such as an OTA MPD, describing the OTT representations as normal, plus the OTA representation with the offloaded segments. For example, the CDN 204 may transmit an OTT representation and the OTA MPD to a public CDN location 206. The OTA MPD that describes the OTT representation directs a receiver, such as the 3.0-enabled device 208, to the location on the broadcast signal for the OTA representation. In some embodiments, the CDN 204 may transmit an OTT MPD and OTT representation segments to a non-3.0 enabled receiver 210. The OTT MPD describes OTT representation segments, but not OTA representation segments because the non-3.0 enabled receiver 210 may not receive the OTA representation segments.

The receiver then begins to tune the signal. Simultaneously, it begins playback from the OTT representation, allowing content to display immediately rather than forcing a pause for the tune time or potentially failing due to poor signal. While this content is playing, the receiver starts to receive the segments. These segments arrive through the broadcast signal exactly how they were ingested, meaning they appear with the same name and time value as the MPD describes. For example, the receiver may receive the segments via the 3.0 airchain 214. Thus, once the requisite signal confidence is reached, the player can cut over to the OTA representation and begin signal playback with a seamless jump to the efficient OTA-delivered segments. The logic behind this is explained in the receiver subsection below.

At this point, the OTT video is successfully offloading onto an OTA delivery mechanism, with no visible impact to the viewer besides potentially higher-quality video.

### MPD Construction and Processing

As noted above, this system utilizes three MPDs, described as follows:
OTT MPD: This is the regular MPD provided to OTT-only clients who request it, which may not be a specific type of MPD but rather the broad category of OTT-only MPDs. This contains the regular CDN locations and is unchanged from the non-broadcast design.
OTA MPD: This is the OTT MPD, but with the broadcast-delivered representation added. This may be a higher weighted representation otherwise identical to another MPD, or it may be a higher bitrate/resolution representation, making use of the greater efficiency of broadcast to deliver a higher quality video. This MPD contains the information to allow the receiver to tune the signal, namely the globally unique globalserviceID (GSID) and radio frequency (RF) channel.
Dummy MPD: This is used to ingest segments into the packager. It contains the OTA representation and may be the only MPD with the broadband location for that representation, which allows the packager to retrieve these segments in the standard method.

GSID is used here for the location rather than service ID or multicast address because the latter two are market-by-market dependent, while the former may be used globally for any unique service. Because the service is identical across the country, stations transmitting that service may have that same GSID for it. Thus, it may be used to reference the service regardless of the receiver location, which is similar to the intent behind the other broadcast stream identification (OtherBsid) portion of the service list table (SLT) signaling, applied on a nationwide scale.

Because an “OTT-first” method is being used where the default is the regular broadband stream that viewers use today, it be may assumed that there is no initial awareness of the 3.0 signal or its contents, nor that any scan has been done. Thus, including just the GSID is not a great option, as it may require a full scan in many situations, which may take minutes to complete. Instead, the RF channel was additionally included. As part of the provisioning process described below, the broadcaster responds to the CDN with information on the spectrum assets allocated to the offload transmission. The CDN may then bake this information into the MPD and deliver the appropriate channel info to each client based on their GeoIP location. While not perfect, it covers most users. With this RF channel information, the receiver is able to manually tune as described in the receiver subsection.

There are a few different options for delivering the broadcast location in the OTA MPD. The first option is the BaseURL element. The intent of this element within the DASH spec is to provide the location of the segments for the DASH components to which it is attached. The use of this to specify the location of the service on the ATSC 3.0 signal is thus in keeping with the goal of this element. For the PoC, the GSID is specified as the BaseURL without any protocol attached. However, Table 30 in the DASH spec notes that the BaseURL is a URL, so it is better to prepend a protocol. The most logical one is the ‘tv’ protocol, which is both flexible and applicable. It is noted that previous drafts utilized channel numbers for identification. The previous situation was, and is, flawed for reasons explained within, but the core concept is helpful for the purposes of the testing here. Instead of simply specifying a channel number, the more sensical approach is to specify the channel and the GSID, noting the channel center and bandwidth to avoid conflicting channel schemes. Thus, the following may constitute a reasonable usage of the tv: protocol in a BaseURL to retrieve this signal: tv: [RF Channel Center]: [RF Channel Bandwidth]: [GSID]. For example, “tv: 539:6: tag: sinclairplatform.com,2020: DEMO2023: 1408”, for a service running on channel 25 (WNUV) in the Baltimore market with a GSID of “tag: sinclairplatform.com,2020: DEMO2023: 1408”. The MPD for the same service being delivered to a client in the Washington, D.C. market may instead use tv: 569:6: tag: sinclairplatform.com,2020: DEMO2023: 1408, running on channel 30 (WIAV).

The second, less elegant option notes the requisite information as a comment using the standard XML syntax. Systems may ignore comments in most situations, so this avoids compatibility issues that could otherwise appear. However, this may be dropped by processes that potentially modify the MPD, as they may discard the comments as unnecessary. Therefore, the BaseURL solution is a better option, assuming it does not cause issues on the receive or transmit side.

### Provisioning Workflow

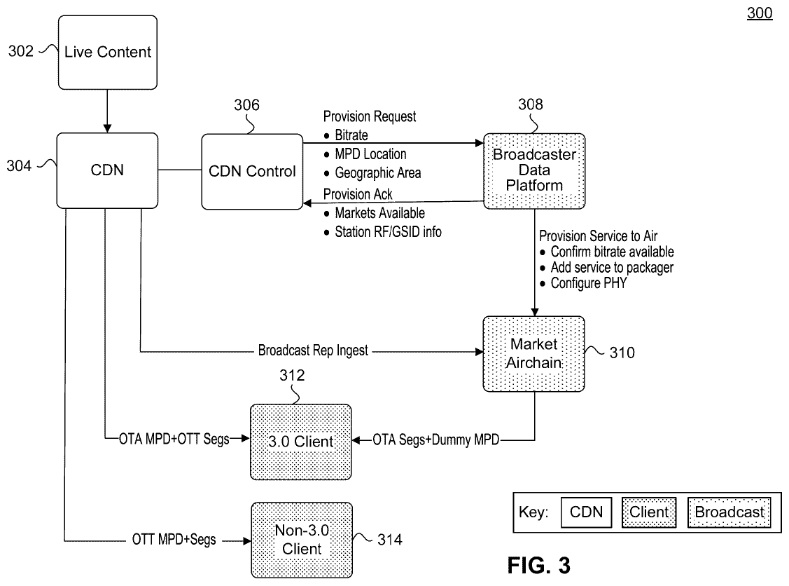

As part of this system, an exchange is made between the CDN and the broadcaster, as neither knows all the puzzle pieces. FIG. 3 demonstrates the process to enable this, according to some aspects. For example, FIG. 3 illustrates an exemplary workflow for provisioning an offload service from a CDN to a broadcaster.

When a CDN 304 desires to offload a stream received from live content 302, for example, a prominent sporting event assured of having high viewership and thus high broadcast efficiency ratios, its system contacts the broadcaster's provisioning platform. It provides the bitrate, the URL of the broadcast MPD, and the desired geographic locations for coverage. The broadcaster's platform, such as a broadcaster data platform 308, then uses that bitrate to determine viable locations for offload. For example, a CDN control 306, which connects to the CDN 304, may transmit the bitrate, one or more MPD locations, and a geographic area to the broadcast data platform 308. The platform responds to the CDN 304 with a list of markets with available capacity, the RF channel in each of those markets to allow for geoIP bounding, and the GSID info for the service to be provisioned in a provision acknowledgement. The CDN 304 then bakes this into the geolocated MPD as described above. In some aspects, the CDN 304 may transmit broadcast representation to a market airchain 310. In other words, the market airchain 310 may ingest the broadcast representation from the CDN 304.

Simultaneously, the broadcaster provisions the services to the selected markets. For example, the broadcaster data platform 308 may provision services to the market airchain 310. The services may include, but not limited to, confirming available bitrate, adding a service to a packager, and configuring PHY. This is the same methodology behind any other use of a data distribution platform, with a combination of calls to other broadcaster platforms and direct provisioning of in-house stations. These provision the segments' ingest to each packager, add the appropriate signaling, and configure the physical layer to support the appropriate bitrate for transmission.

### Signaling

The signaling in this system is remarkably normal for linear audio-visual (AV) services, with minimal modifications. In the SLT, the service is identified as standard, with a name, ID, the GSID, and so on. One difference is that it is marked as “hidden” and “hideinguide,” which prevents it from appearing unintentionally on TV interfaces, as it is a) not a complete service and b) not intended for general consumption.

In the service layer signaling (SLS), the user service bundle description (USBD) and a service transport stream identifier (S-TSID) are configured as standard. The MPD contains the information from the dummy MPD, allowing the receiver to identify the names and transport object identifiers (TOIs) of the segments for retrieval from the ROUTE sessions, even though it will not use this MPD for playback. Note that the BaseURL is not provided in the MPD, as this is not designed for the complete product with the broadband components. In theory, the MPD could be skipped entirely, with files just sent in regular ROUTE sessions with no MPD associated, but this dramatically reduces the implementation barrier as it allows the use of existing methods.

### Receiver Processing

The receiver is a crucial part of the successful display of this system, as it assembles the constituent parts into a cohesive whole. It may also need to be able to handle situations of no 3.0, poor 3.0, and good 3.0 coverage without displaying any disruption to the viewer experience. If it is a non-3.0 device 314, the process includes: Reach out, retrieve the MPD, and stream the playback via broadband. For example, the non-3.0 device 314 may receive OTT MPD and segments from the CDN 304. If, however, it is a 3.0 device 312, then when it reaches out for the MPD, it may additionally have the 3.0 information described above.

The first objective is, therefore, to be able to use that 3.0 information to begin retrieving segments. There are a few possible situations that may develop:
GSID in Saved Scan: The receiver has scanned the local spectrum and saved a service with the relevant GSID. It may immediately tune and begin pulling the segments.
No Scan with GSID, RF in MPD: This is likely the most common scenario, as in the event of on-the-fly provisioning, it is unlikely the service was present when the receiver was last scanned, if at all. In this scenario, the receiver may scan just the listed RF channel and pull the segments if successful. If that fails, for example, due to a GeoIP miss, it may proceed with the third scenario.
No Scan with GSID, no RF in MPD: In this scenario, the MPD does not contain information on an RF channel, which could result from a lack of information provided to the CDN 304 or a GeoIP issue. In this scenario, the receiver scans the full spectrum to locate the listed GSID.

Each scenario takes progressively more time, from a few seconds for the first to a few minutes for the last. Luckily, the receiver also has the regular OTT ladder and may begin playing this back, though with some potential adjustments for timing as described in the Timing subsection.

Now, the receiver has successfully started pulling down both OTT and OTA. For example, the 3.0 client 312 may receive OTT segments from the CDN 304 and may receive OTA segments from the market airchain 310. However, this provides no benefit to the viewer or CDN 304 yet, as the viewer is still utilizing the broadband connection and does not see any potentially better video streams being delivered over the air. Thus, the next step is making the transition to the OTA representation.

While it may be tempting, simply jumping directly to OTA the moment the first segment arrives may compromise the seamless viewing experience. In situations where reception is on the edge, segments may arrive intermittently, causing rapid jumps up and down between the OTA and OTT representations. Therefore, the better approach is to wait until a pre-defined level of confidence is reached in the reliability of the OTA reception, as the OTT stream may continue to function in the meantime. This may be done using an initial estimate based on the reported signal-to-noise ratio (SNR) at the receiver compared to the threshold estimate for the physical configuration provided in A/327 Appendices A and B. While imperfect, this may give us a ballpark percentage for the odds of receiving a given signal. Once this estimate is calculated, it may be used as the prior probability in Bayes' Rule to determine the posterior probability that segments will be received. The segment reception may be treated as a Bernoulli trial with the outcomes either being successful reception or failed reception, which allows us to obtain a decision more rapidly on whether to use the OTA segments in comparison to a frequentist approach, which does not utilize our prior knowledge advantage and therefore may require a larger dataset to achieve the necessary confidence.

The level of confidence that may be required for the changeover is ultimately up to the requirements of the company utilizing the system. Given that most people may receive either all or none of the segments, with only a portion of the population in a grey area, it can be concluded quickly if the signal condition is good. At this time, the player may play OTA segments instead, and may avoid using the CDN 304 and incur charges for distribution. After all, these segments are the very same segments generated by the encoder used in that MPD, so they seamlessly align with the OTT representations. The process of synchronization is described in the Timing subsection. Once these segments are served up via the local hypertext transfer protocol (HTTP) proxy server, the system may rewrite the BaseURL in the MPD to direct the player to reference that proxy server for the representation, and it may begin playing them out as if they had been delivered over broadband the entire time.

### Timing

Timing is ultimately a main factor for this system. It is clear that segments may be delivered via broadcast, as that is a core component of 3.0, and segments may be delivered via broadband, as that is utilized both in 3.0 and in streaming services. The difficulty is putting those together in a live environment, where the trip time for the broadcast and broadband paths is very different due to the vagaries of CDN, such as the CDN 304, distribution methods, internet infrastructure, and broadcast delivery, which is part of what leads to broadcast, cable, and each streaming service having different levels of delay from true live. The delays from true live on platforms airing the 2024 Super Bowl, for example, ranged from 22 seconds for OTA at the shortest, all the way to nearly 90 seconds for the longest, the streaming service FuboTV™.

One of the advantages of a segment-based system like DASH is that it is designed around switching between video streams as a foundational concept of the spec, as this allows laddering between different bitrates based on the speed of the user's connection. Each representation within an adaptation set has to be time-aligned, so switching from one representation to the next provides a seamless experience. The spec ensures that when doing so, the segments are non-overlapping and able to be concatenated.

Another item to be addressed is the “SegmentTimeline,” which provides a list of segments, named either sequentially by number or by the time that has elapsed since the start of the MPD. This allows the player to determine what segment to play to get the video for a particular time in the sequence, and vice versa.

With this knowledge, the two representations for playback may be synchronized. This may be quite simple in a world where the broadcast segment arrived at the same time that the broadband segment became available, as that is standard practice in DASH. But unfortunately, the two are expected to arrive at different times.

Fortunately, this may be compensated for by offsetting playback to ensure both arrive. Rather than playing out the segments at the intended time, that playback can be delayed by playing an earlier segment in the timeline until it is certain that each segment will arrive. This delay number may vary based on configuration and environmental factors, as explored later in this subsection and the Challenges section, respectively. Beyond those, some other factors to consider for acceptable delay are the cache available in the receiver to store segments ahead of playback and the tolerable delay compared to live for the user and the streamer.

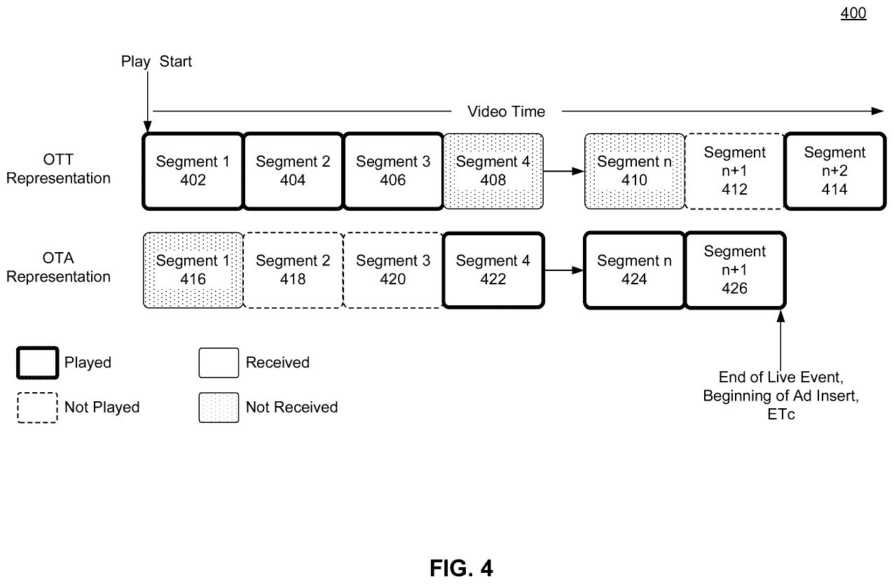

Once these are all accounted for, the sequence may be played out as if both were available at the same time, as demonstrated in FIG. 4. FIG. 4 illustrates an exemplary sequence of video playback, according to some aspects. This shows which segments may be retrieved off the 3.0 signal or a CDN, such as the CDN 204 or the CDN 304, and which segments may be played from each representation. Specifically, a device, such as the 3.0 enabled receiver 208 and the client 312, may receive an OTT representation comprising segments 402, 404, 406, 408, 410, 412 and 414. In addition, the device may receive an OTA representation comprising segments 416, 418, 420, 422, 424, and 426. Segments from the OTT representation and the OTA representation may overlap in time. For example, the segments 402 and 416 overlap in time. In some aspects, the device may receive a mixed set of segments. For example, the device may receive the segments 402, 404, 406, 412, 414, 418, 420, 422, 424, and 426. Thus, the device receives a portion of the OTT representation and a portion of the OTA representation to switch between the OTT representation and the OTA representation. For example, the device may initially play the segment 402 when play starts. The device may continue to play the segments 404 and 406. In some aspects, the device may receive the segments 418 and 420 that overlap with the segments 404 and 406 in time respectively. In other words, the device may choose to play segments 404 and 406 even though the device can play the segments 418 and 420 instead. This may be because a confidence level of the OTA representation is not high enough during video time of the segments 418 and 420. Moving forward, the device may play the segment 422, the segment 424, any segments between them, and the segment 426, which may be the last segment of a live event. After that, the device may switch back to the OTT representation and play the segment 416. Similarly, the segment 412 of the OTT representation overlaps in time with the segment 426 of the OTA representation. The device may choose to play the segment 426 because a confident level of the OTT representation is not high enough yet during video time of the segment 412. Another question is when along the CDN process to ingest the segments. This is because CDNs generally have a pyramidal structure, where the origin is distributed to various nodes for final delivery to each geographic and network grouping of end users. What this means for the broadcast chain is that either can be pulled from the end of that chain, guaranteeing that it will be behind the CDN-delivered stream, or from the exact origin, potentially putting it closer or even ahead of the end user's CDN-delivered stream. The delay in the former case comes because, sadly, time travel has not been invented yet, and so if the air chain pulls from the same node as the end user and then adds a few seconds of delay to transit the air chain, it therefore arrives to the end user after the broadband segments. There are pros and cons to each of these options.

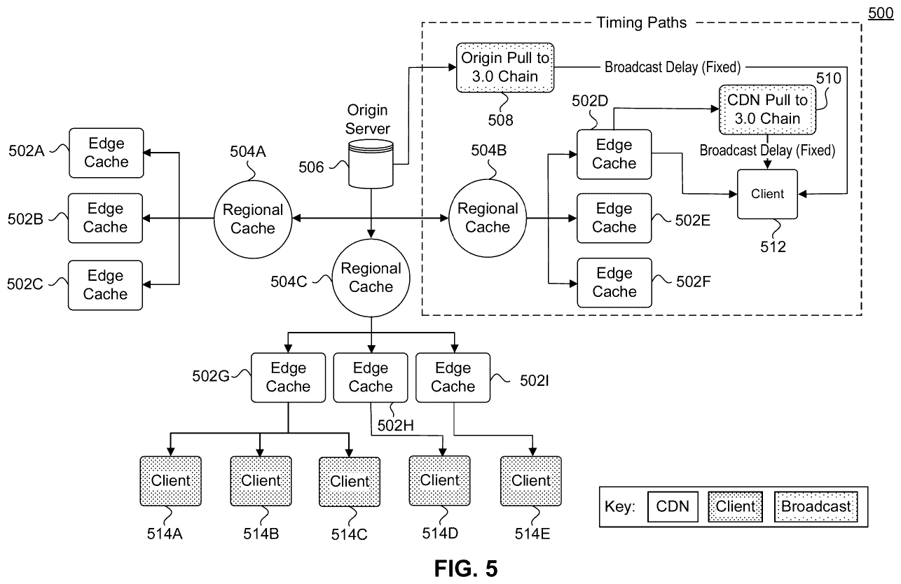

FIG. 5 illustrates an exemplary generalized CDN architecture, according to some aspects. In some aspects, an origin server 506 can serve regional cache 504A, 504B and 504C, which may transmit content to their respective edge caches. For example, the regional cache 504A can transmit content to edge caches 502A, 502B, and 502C. For another example, the regional cache 504B can transmit content to edge caches 502D, 502E, and 502F. For yet another example, the regional cache can transmit content to edge caches 502G, 502H, and 502I. The edge caches 502G, 502H, and 502I can further transmit the content to their respective clients 514A, 514B, 514C, 514D, and 514E. The top right shows the two possible paths for ingest into the airchain, and the accompanying time differences.

For the origin pulls, such as an original pull from 508 to a 3.0 chain that arrives at a client 512, the big win is that the OTT need not be held back much, or potentially at all, to synchronize the streams. This is because the broadcast segments may be arriving around or before when the OTT segments appear in the CDN and are described in the OTT MPD, as they skip the delays of the CDN distribution process. For example, the client 512 may also receive broadcast from a CDN pull 510 from an edge cache, such as the edge cache 502D. However, this has downsides. Each packager may pull from the origin directly, increasing its load. This, though, may be alleviated through a central packager distribution mechanism, wherein the ROUTE packaging is done by one device, then sent out to each station using the station group's network. It also likely that the receiver utilizes more cache, as broadcast segments may only be sent once and are to be stored until they are ready for playout. It also may not provide an adequate offset to eliminate the delay compared to the OTT segments.

For CDN pulls, less cache is needed, as the CDN may be relied upon to continue to have the segments available, which means it likely has to store only a few segments for smooth playback. However, it may incur a delay compared to the normal CDN distribution. In the real-world PoC, it is found that around 6 seconds was the norm, though this varied depending on testing location and airchain configuration. It also overestimates the delay between the two, as if playback of the broadband segments is started too close to current in the timeline, the broadcast may not catch up, eliminating the benefits of the offload.

### Section 4: Challenges

Naturally, a system of this scale with numerous moving parts involves many challenges, ranging from differences in standard practices to features not designed with such a system in mind and even to fundamental issues with the laws of physics. The first set of issues stems from differing methods of operation, with one system designed for broadcast and the other for broadband. Segment length was the first notable one for broadcast; it was targeted as small a segment length as possible while preserving the quality enabled by a longer group of pictures (GOP) at the same bitrate. In most receivers, this enables a shorter tune time when using DASH-ROUTE, as the receiver does not have to wait as long to receive an entire segment. Note that most of our chunk and segment lengths are set the same.

Meanwhile, in broadband, tune time from segment length has less impact, as the receiver may download at greater than actual time speeds, which was part of the basis of the Sony™/Harmonic™/Weigel™ IP channel trial. This means that for broadband, the ideal time is often somewhat longer, as lower segment times may reduce latency and the time to scale up between representations, but at the same time, may increase the possibility of buffering as it catches the edge of availability and decrease the quality due to a shorter GOP length. In our testing, the CDN ended up with 2-4 seconds, rather than the 1-2 seconds usually used on broadcast-only.

Another item was the MPD format. DASH is a versatile spec with numerous features and ways of generating the MPD. A subset of these is identified in the DASH Interoperability Point for ATSC 3.0, limiting the number of items our airchains generally need to be concerned with. Also, segment locations are generally not altered, as there is no need when the encoder is sending them directly to the ROUTE packager. CDNs, on the other hand, gain an advantage by using these systems, particularly those around segment location, flags for different features, and per-user dynamic MPDs, and so integrating that ingest into our various airchains proved quite challenging. With the assistance of various packager partners, it is possible to adapt to the situation, but not without quite an effort.

Ad insertion and trick play, or even the concept of rewinding, are items that are not currently utilized in production. DRM, meanwhile, is used in production by other broadcasters, but not in the same way as many broadband streamers. Luckily, the former two are made quite simple with the addition of the broadband MPD, as they may be signaled as they would for an all-broadband sequence. This does mean that in the event the broadcast representation has better quality than the broadband one, the user may notice a quality drop on rewinding, or when an inserted ad plays, regardless of server-side ad insertion (SSAI) or client-side ad insertion (CSAI) based ads, but the system may still function as normal, and return to the broadcast representation once the ad is done or the user has resumed real-time playback.

Digital rights management (DRM), on the other hand, has some additional complexity. A single-key method, as is used by those broadcasters utilizing encryption on their services, is just as functional on the broadcast representation as on the broadband one. However, when it comes to multi-key, the system breaks down. In this situation, you may not be able to perform multi-key encryption on the broadcast representation, as everyone receives the same broadcast segments, may require the same key for decryption. Any in-flight encryption like this may result in a glorified single-key setup. This is something intend to be examined further, as no test has been done with DRM at all at present, but as it stands, the primary option is accepting that it may be single key.

Last is the matter of physics, which is a fancy way of saying ‘timing issues.’ As noted in the previous section, timing has several factors. One of the more painful issues encountered was the lack of a fixed delay number. This would have different results in different locations depending on the latency of the receiver pulling off the CDN compared to the latency of the airchain. This latency generally ranged from a four second to ten second delay between the broadband and broadcast representations. An additional confounder unlikely to be seen in the real world is the latency generated from our secure reliable transport (SRT)-based studio to transmitter link transport protocol (STLTP) distribution network for testing the same airchain in different facilities. While SRT is famously low latency, it still contributed to an increase in latency, with different behavior in cach facility.

Our solution for our PoC was to delay playback to the shortest safe delay, which was six seconds in our test market. Another option to work around this is the aforementioned origin pull, which helps slim the margin. The actual delay may be calculated by assessing when the segments become available via broadband and broadcast and calculating the difference, which does not help with the active playback session, but may be remembered for future sessions and adjusted downwards.

In the long run, the best option seems to be an on-the-fly adjustment model. In this system, the delay may begin at a certain point and then adapt downwards or upwards based on the segment arrival time difference. This may also be done by adjusting the playback speed of the active segments, say to 1.01 x or 0.99 x, so that slowly, over time, the difference between the current point in playback and the actual live point gets further or closer. Thus, if the starting delay is too short, cach segment may be played back slower until the appropriate starting delay is achieved; at this point, normal speed playback is resumed.

### Section 5: Real World

Theory without practical testing is often difficult to accept. In December 2023, a real-world, on-air proof of concept of this system was conducted in Seattle, on a full power 3.0 host in the market, KUNS. Remaining within spectrum allocation, a 10 mbps video representation was sent out over the air as a hidden service with the same receivability as regular services in that market. The channel did not appear on their receivers for ordinary viewers in the market, nor should it have impacted their viewing experience.

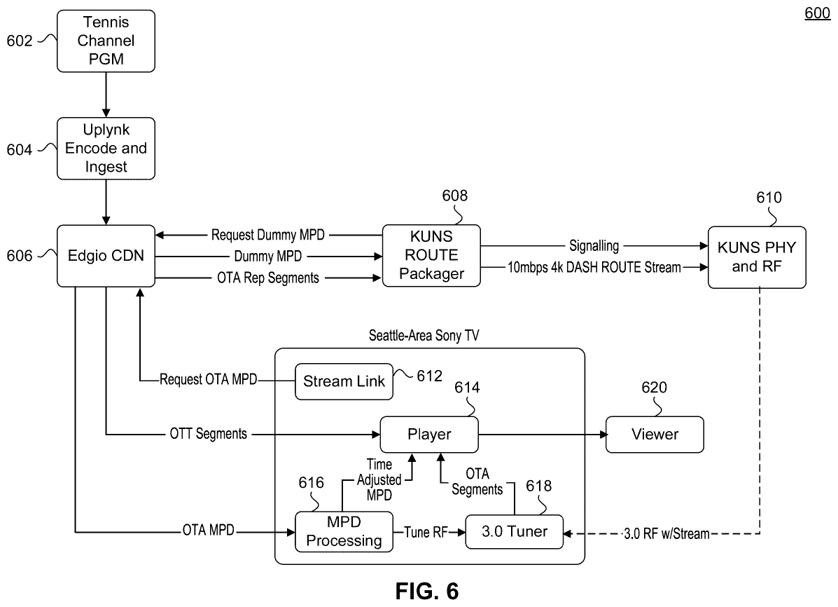

FIG. 6 illustrates an exemplary demo configuration for the Seattle proof of concept, according to some aspects.

This video representation was ingested as a live feed from the Tennis Channel, such as a tennis channel program (PGM) 602, and sent through our CDN partner Edgio's Uplynk system for encoding, distribution, and MPD generation at Uplynk system 604 and Edgio CDN 606. In some embodiments, the Uplynk system 604 can also be replaced with other streaming platforms. Edgio then configured their system to dynamically generate the three key MPDs, as described previously, which allowed us to ingest the top representation, the 10 mbps feed, into our packager in the local market. For example, the Edgio CDN 606 may transmit a dummy MPD and OTA representation segments to a packager, such as a KUNS ROUTE Packager 608, in response to a request for dummy MPD received from the KUNS ROUTE Packager 608. The KUNS ROUTE Packager 608 may transmit signling and stream, such as a 10 mbps 4 k DASH ROUTE stream, to KUNS PHY and RF 610. The KUNS PHY and RF 610 can then transmit streams via 3.0 RF to a 3.0 tuner 618. In summary, it did the necessary signaling and ROUTE packaging and sent it through the rest of the airchain, giving us a constant feed over the air in Seattle. In some embodiments, the KUNS ROUTE Packager 608 and the KUNS PHY and RF 610 can be replaced with other broadcast systems. The sample app may include a stream link 612 configured to transmit a request for OTA MPD, a player 614 configured to receive OTT segments from the Edgio CDN 606 and showing content to a viewer 620, a MPD processing 616 configured to receive an OTA MPD from the Edgio CDN 606 and transmit time adjusted MPD to the player 614, and the 3.0 tuner 618 configured to receive tune RF from the MPD processing 616 and transmit OTA segments to the player 614. This ability to run on consumer sets is vital to a production rollout, as will be explored in the next section.

The PoC application was spun up, which pulled down the broadband MPD, began playback of the OTT stream at a chosen delay, and then tuned to the signaled channel. Once the confidence was high enough, it seamlessly switched over to the OTA representation, without a single glitch, flawlessly demonstrating the viability of this concept. The lip-sync component of the demonstration, where the audio was sent over broadband and the video was sent over broadcast was successful, demonstrating that the two were being played back perfectly in sync. The tennis content was beneficial here, as it is a distinctly timed sound when the ball hits the ground or a racket. Because it was the actual Tennis Channel feed, attendees could also see the same video being sent over traditional cable, showing that it was a live system.

The configurable delay was vital to test the delay between the two for seamless failover in a real-world scenario, which is what led us to note the drastic differences in delay by geographic location, as well as the rough average of six seconds for a safe playback in the configured scenario.

### Receivers

A main factor is receiver integration. This system can be configured so that third-party streaming apps are able to access data from a 3.0 signal, which is not a function commonly catered to in today's receivers. Indeed, most keep the hardware access to the tuner isolated to specific applications on their sets, which avoids the potential issue of conflicts over hardware control and the potential danger of that access. However, these problems may be addressed, especially given that the expectation is a few whitelisted applications rather than mass consumption of this service across the board. After all, the spectrum is limited, and there are only so many significant tent pole events occurring at a given moment.

Without this integration, we're limited to the gateway model, using devices like the popular HDHomeRun from SiliconDust. These devices are well known amongst primary OTA viewers but less so for those who primarily consume streaming content, like most viewers of these services would be. Thus, it is better to have across-the-board implementation than to have to encourage the purchase of additional hardware in homes. The more households with receivers supporting this, the more efficient the system is compared to broadband.

There are clear advantages to the receivers, as this system allows streamers to provide better video content to the viewer for cheaper, encouraging increased quality.

Better-looking sports and other live events are a great way to sell TVs to customers, particularly the oft advertised 4 k content. Anything that enables that is a step in the right direction for everyone involved. It provides both a reason to buy TV brands supporting this system and to buy ATSC 3.0-enabled TV sets specifically.

There are two primary ways of achieving this between the two main receiver categories: direct video players (e.g., the various TVs and high-definition multimedia interface (HDMI) set-top boxes), and gateway devices (e.g., the HDHomeRun). For the former, the tuner may be accessed directly or through the TV's middleware to retrieve the segments, which may then be utilized as described in the receiver portion of Section 3. For the latter, it opens some additional options, as a gateway representation that lists the local address of the gateway in the BaseURL can be sent using multicast domain name system (mDNS) or similar. This may still require the timing logic on the streaming device, but it may allow us to pull down the OTA representation even on devices that lack a 3.0 tuner, such as, cell phones, tablets, computers, and older televisions. Doing this may dramatically expand the impact of the offload system, as it could offset just about any usage of the live stream in the household.

### Streamers

The other side of the coin is the streamer integration. The first barrier is getting streamers to use this system. Much like the receivers, there are clear benefits to doing so, as the cheaper cost of this distribution offsets the ever-rising delivery costs. Another factor is that it is a ‘broadband first’ system, so anyone who lacks a device that supports this will still be able to pull the streams down. It is a supplemental benefit rather than a shift to the underlying architecture. Integration of such functionality into their applications is a goal. A standardized TV interface for access to 3.0 signals by third-party apps make this an attractive option, as integrating against one application programming interface (API) is dramatically easier than integrating against a different API for all ATSC 3.0 set manufacturers. Additionally, a software development kit (SDK) that sits between the streaming app and the 3.0 system and handles the processing of the 3.0 input likely helps reduce the complexity of this integration, as it keeps the required additional knowledge low, abstracting it to the same DASH they are familiar with instead of the new concept of ATSC 3.0.

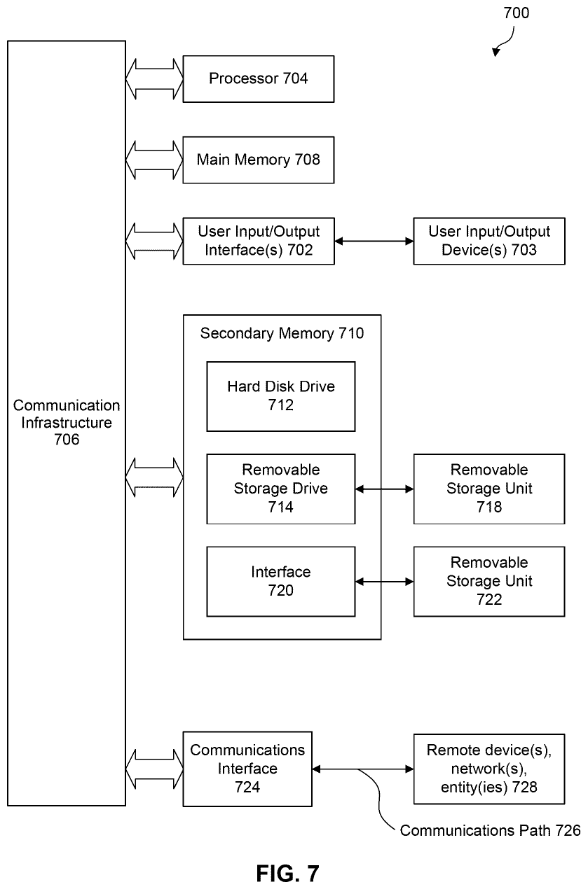

Various aspects may be implemented, for example, using one or more computer systems, such as computer system 700 shown in FIG. 7. Computer system 700 can be any well-known computer capable of performing the functions described herein such as ATSC 3.0 enabled receiver of FIG. 2. Computer system 700 includes one or more processors (also called central processing units, or CPUs), such as a processor 704. Processor 704 is connected to a communication infrastructure 706 (e.g., a bus). Computer system 700 also includes user input/output device(s) 703, such as monitors, keyboards, pointing devices, etc., that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to some aspects, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726. In some embodiments, the communication interface 724 may include TV tuners or RF tuners.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 7. In particular, aspects may operate with software, hardware, and/or operating system implementations other than those described herein.

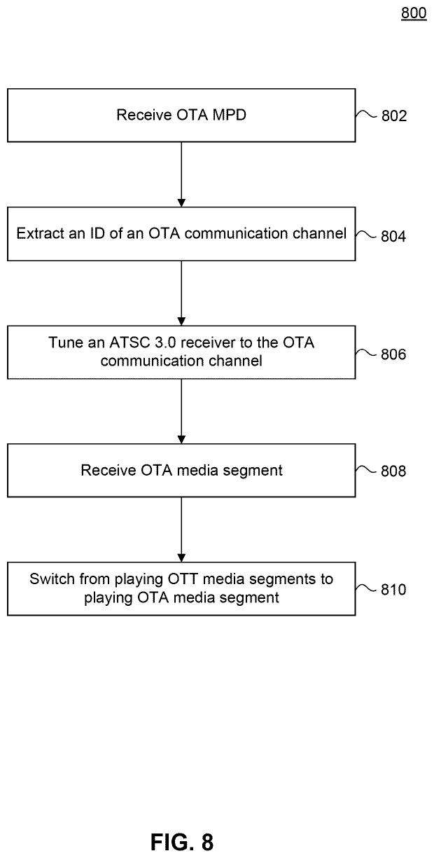

FIG. 8 illustrates an example method 800 of offloading media segments, according to aspects of the disclosure. The example method 300 is provided for the purpose of illustration only and does not limit the disclosed aspects. As a convenience and not a limitation, FIG. 3 may be described with regard to elements of FIGS. 2, 3, 5, and 6. The example method 800 may also be performed by the computer system 700 of FIG. 7. But the example method 800 is not limited to the specific aspects depicted in those figures and other systems may be used to perform the method, as will be understood by those skilled in the art. It is to be appreciated that not all operations may be needed, and the operations may not be performed in the same order as shown in FIG. 8.

At 802, a media client device, such as the 3.0 enabled receiver 208 in FIG. 2 and the 3.0 client 312 in FIG. 3, receives an over the air (OTA) MPD over an OTT communications channel. The OTA MPD corresponds to a plurality of OTT media segments and a plurality of OTA media segments, and wherein the plurality of OTA media segments and the plurality of OTT media segments correspond to a same time period of a media program.

At 804, the media client device extracts an identifier corresponding to an OTA communications channel from the OTA MPD.

At 806, the media client device tunes a receiver of the media client device to the

OTA communication channel.

At 808, the media client device receives one or more OTA media segments of the plurality of OTA media segments over the OTA communications channel using the receiver.

At 810, the media client device switches from playing a representation of a media program from one or more OTT media segments of the plurality of OTT media segments to playing another representation of the media program from the one or more OTA media segments of the plurality of OTA media segments.

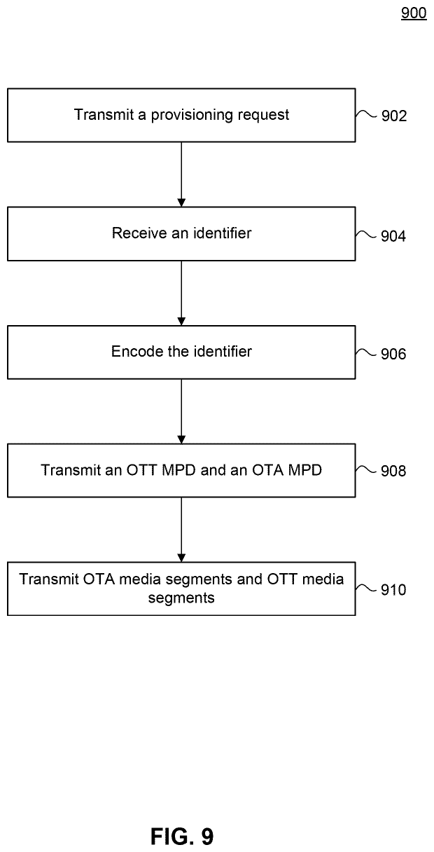

FIG. 9 illustrates an example method 900 of transmitting media segments, according to aspects of the disclosure. The example method 900 is provided for the purpose of illustration only and does not limit the disclosed aspects. As a convenience and not a limitation, FIG. 9 may be described with regard to elements of FIGS. 2, 3, 5, and 6. The example method 900 may also be performed by the computer system 700 of FIG. 7. But the example method 900 is not limited to the specific aspects depicted in those figures and other systems may be used to perform the method, as will be understood by those skilled in the art. It is to be appreciated that not all operations may be needed, and the operations may not be performed in the same order as shown in FIG. 9.

At 902, a system, such as the system FIGS. 2 and 3, transmits a provisioning request to a broadcast provisioning platform.

At 904, the system receives an identifier corresponding to an over the air (OTA) communications channel from the broadcast provisioning platform.

At 906, the system encodes the identifier corresponding to the OTA communications channel in an OTA media presentation description (MPD).

At 908, the system transmits an over the top (OTT) MPD and the OTA MPD over an OTT communications channel to a media client device. The OTT MPD corresponds to a plurality of OTT media segments and the OTA MPD corresponds to a plurality of OTA media segments, and wherein the plurality of OTA media segments and the plurality of OTT media segments correspond to a same time period of a media program.

At 910, the system transmits the plurality of OTA media segments to an Advanced Television Systems Committee (ATSC) 3.0 broadcast node transmits one or more OTT media segments of the plurality of OTT media segments over the OTT communications channel to the media client device. The media client switches from playing the media program from one or more OTT media segments of the plurality of OTT media segments to playing the media program from the one or more OTA media segments of the plurality of OTA media segments.

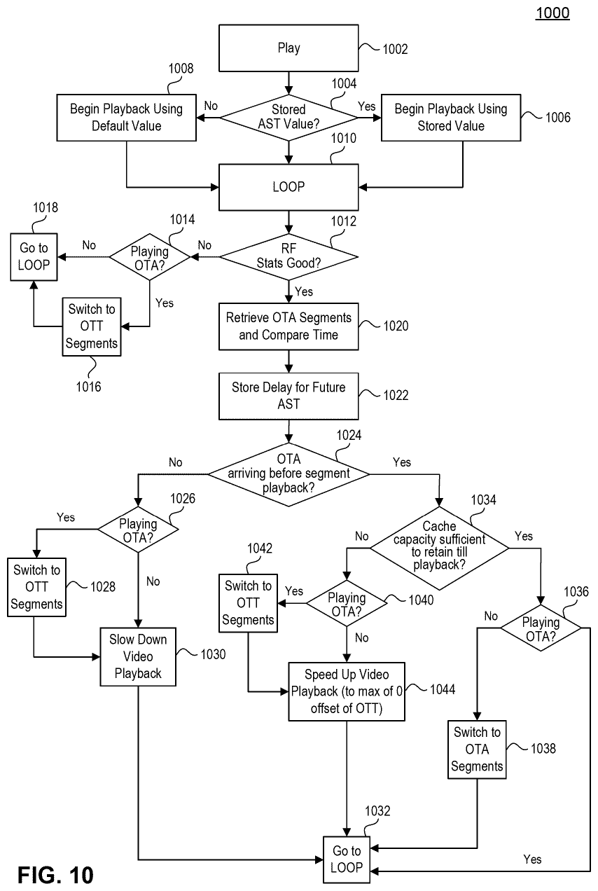

FIG. 10 illustrates an exemplary method of switching between OTT segments and OTA segments while playing content, according to aspects of the disclosure. The example method 1000 is provided for the purpose of illustration only and does not limit the disclosed aspects. As a convenience and not a limitation, FIG. 10 may be described with regard to elements of FIGS. 2, 3, 5, and 6. The example method 1000 may also be performed by the computer system 700 of FIG. 7. But the example method 1000 is not limited to the specific aspects depicted in those figures and other systems may be used to perform the method, as will be understood by those skilled in the art. It is to be appreciated that not all operations may be needed, and the operations may not be performed in the same order as shown in FIG. 10.

At 1002, a client device, such as the 3.0 enabled receiver 208 in FIG. 2 or the 3.0 client 312 in FIG. 3, starts to play streaming content, such as a sports game. For example, the client device may receive an instruction from a user to play the streaming content.

At 1004, the client device determines whether an availability start time (AST) value has been stored. In some embodiments, the AST value may indicate a segment to be played, either an OTT segment or an OTA segment. If an AST value is stored in the client device, the control moves to 1006.

At 1006, the client device plays a segment corresponding to the AST value. In such a case, a loop started at 1010.

Referring back to 1004, if the client device determines that an AST value is not stored in the client device, the control moves to 1008. At 1008, the client device may determine a default AST value and play a segment corresponding to the default AST value. Then the control moves to 1010 to start the loop.

At 1012, the client device determines whether an RF condition is satisfied. For example, the client device may measure signal strength, signal quality, or other parameters of received signals. If the measured parameter is below a signal threshold, the client device may determine that the RF condition is not satisfied. In such a case, the control moves to 1014.

At 1014, the client device determines whether it is currently playing OTA segments. If the client device is playing OTA segments, the control moves to 1016 and the client device switches to play OTT segments. Otherwise, the control moves to 1018 and the client device returns to the beginning of the loop. For example, the client device checks again whether the RF condition is satisfied. In other words, the client device keeps checking the RF condition until the RF condition is satisfied.

Referring back to 1012, if the client device determines that the RF condition is satisfied, the control moves to 1020. At 1020, the client device retrieves OTA segments. The client device may also compare retrieve time of the OTA segments and retrieve time of the OTT segment to determine a delay time.

At 1022, the client device may store the delay time for future AST.

At 1024, the client device may determine whether the OTA segment arrives before segment playback. For example, the client device may have 5 segments to be played, either via OTT segments or OTA segments. The client device may currently play or is currently configured to play a segment no. 2 out of the 5 segments. If an OTA segment no. 2 is not yet received, the client device may determine that the OTA segments do not arrive before the segment is played. In such a case, the control moves to 1026.

At 1026, the client device determines whether it plays OTA segments. If the client device determines that it currently plays an OTA segment, the control moves to 1028. Specifically, because the OTA segments do not arrive before the segment is played, the playback is delayed in this case. For example, the client device may be configured to play the segment no. 2. However, the OTA segment no. 1 is the recent segment. Thus, to play OTA segments, the client device is forced to play the OTA segment no. 1 because the OTA segment no. 2 is not available yet.

At 1028, the client device switches to OTT segments, which are not delayed. The control then moves to 1030.

Referring back to 1026, if the client determines that the client device is playing OTT segments, the control also moves to 1030. At 1030, the client device slows down video playback via the OTT segments. Slowing down the video playback may allow the OTA segment arriving time to catch up. In some embodiments, the client device may adjust playing speed for a small amount so that a user of the client device does not notice the change. The control then goes to 1032 and the client device starts the loop over from 1012.

Referring back to 1024, if the client device determines that the OTA segments arrive before the segments playback, the control moves to 1034.

At 1034, the client device determines whether the cache capacity is sufficient to retain OTA segments until they are played. For example, the cache capacity may be 2 segments. The client device may determine that currently the OTA segment no. 2 is played and an OTA segment no. 3 has already arrived. Before the client device finishes playing the OTA segment no. 2, an OTA segment no. 4 may also arrive, but an OTA segment no. 5 will not arrive. In such a case, the OTA segment no. 3 and potentially the OTA segment no. 4 can be stored in a cache of the client device until the OTA segment no. 2 finishes playing and the OTA segment no. 3 starts to play. In such a case, the client device determines that the cache capacity is sufficient and the control moves to 1036.

At 1036, the client device determines whether it plays an OTA segment. If no, e.g., the client device is playing an OTT segment, the client switches to play OTA segments at 1038. The client device then starts the loop over from 1012. If the client device determines that it plays an OTA segment, client device also starts the loop over from 1012.

Referring back to 1034, the client device may determine that the cache capacity is not sufficient. For example, the cache capacity may be 1 segment. The client device may determine that currently the OTA segment no. 2 is played and the OTA segment no. 3 has already arrived and stored in the cache. Thus, the cache is full. However, before the client device finishes playing the OTA segment no. 2, the OTA segment no. 4 may also arrive. In such a case, the client device may be forced to remove the OTA segment no. 3 stored in the cache or drop the OTA segment no. 4. Either way, the client device may lose an OTA segment. In such a case, the control goes to 1040.

At 1040, the client device determines whether it currently plays OTA segments. If no, the control moves to 1044 and the client device speeds up video playback. Thus, segments will be played faster so that the cache may be cleared before additional OTA segments arrive. If the client determines that it currently plays OTA segments, the control moves 1042 and the client device switches to play OTT segments. The client device then speeds up video playback as well. In either case, after speeding up the video playback, the client device starts the loop over from 1012.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

What is claimed is:

1. A method, comprising:
receiving, at a media client device, an over the air (OTA) media presentation description (MPD) over an OTT communications channel, wherein the OTA MPD corresponds to a plurality of OTT media segments and a plurality of OTA media segments, and wherein the plurality of OTA media segments and the plurality of OTT media segments correspond to a same time period of a media program;
extracting, from the OTA MPD, an identifier corresponding to an OTA communications channel;
tuning a receiver to the OTA communication channel;
receiving, using the receiver, one or more OTA media segments of the plurality of OTA media segments over the OTA communications channel; and
switching from playing a representation of a media program from one or more OTT media segments of the plurality of OTT media segments to playing another representation of the media program from the one or more OTA media segments of the plurality of OTA media segments.

2. The method of claim 1, wherein the switching further comprises:
measuring a quality of signal received over the OTA communications channel; and
switching to playing the media program from the one or more OTA media segments in response to the quality of signal received over the OTA communications channel exceeding a threshold value.

3. The method of claim 1, further comprising:
sequentially aligning the one or more OTT media segments and the one or more OTA media segments using the OTT MPD and the OTA MPD.

4. The method of claim 1, wherein the another representation of the media program played from the one or more OTA media segments has a higher resolution or a higher bitrate than the representation of the media program played from the one or more OTT media segments.

5. The method of claim 1, wherein the OTA media segments and the OTT media segments encapsulate dynamic adaptive streaming over hypertext transfer protocol (HTTP) (DASH) protocol segments corresponding to the media program.

6. The method of claim 1, wherein the identifier is a global service identifier (GSID) of the OTA communications channel.

7. The method of claim 1,
wherein receiving the one or more OTA media segments of the plurality of OTA media segments further comprises receiving from a 3.0 airchain,
wherein the receiver is an Advanced Television Systems Committee (ATSC) 3.0 receiver.

8. A media client device, comprising:
a memory; and
at least one processor coupled to the memory and configured to:
receive an over the air (OTA) media presentation description (MPD) over an OTT communications channel, wherein the OTT MPD corresponds to a plurality of OTT media segments and the OTA MPD corresponds to a plurality of OTA media segments, and wherein the plurality of OTA media segments and the plurality of OTT media segments correspond to a same time period of a media program;
extract, from the OTA MPD, an identifier corresponding to an OTA communications channel;
tune a receiver to the OTA communication channel;
receive, using the receiver, one or more OTA media segments of the plurality of OTA media segments over the OTA communications channel; and
switch from playing a representation of a media program from one or more OTT media segments of the plurality of OTT media segments to playing another representation of the media program from the one or more OTA media segments of the plurality of OTA media segments.

9. The system of claim 8, wherein to switch, the at least one processor is further configured to:
measure a quality of signal received over the OTA communications channel; and
switch to playing the media program from the one or more OTA media segments in response to the quality of signal received over the OTA communications channel exceeding a threshold value.

10. The system of claim 8, wherein the at least one processor is further configured to:
sequentially align the one or more OTT media segments and the one or more OTA media segments using the OTT MPD and the OTA MPD.

11. The system of claim 8, wherein the another representation of the media program played from the one or more OTA media segments has a higher resolution or a higher bitrate than the representation of the media program played from the one or more OTT media segments.

12. The system of claim 8, wherein the OTA media segments and the OTT media segments encapsulate dynamic adaptive streaming over hypertext transfer protocol (HTTP) (DASH) protocol segments corresponding to the media program.

13. The system of claim 8, wherein the identifier is a global service identifier (GSID) of the OTA communications channel.

14. The system of claim 8,
wherein to receive the one or more OTA media segments of the plurality of OTA media segments, the ATSC 3.0 receiver is further configured to receive from a 3.0 airchain, and
wherein the receiver is an Advanced Television Systems Committee (ATSC) 3.0 receiver.

15. A system, comprising:
a memory; and
at least one processor coupled to the memory and configured to:
transmit a provisioning request to a broadcast provisioning platform;
receive an identifier corresponding to an over the air (OTA) communications channel from the broadcast provisioning platform;
encode the identifier corresponding to the OTA communications channel in an OTA media presentation description (MPD);
transmit, to a media client device, the OTA MPD over an over the tope (OTT) communications channel, wherein the OTA MPD corresponds to a plurality of OTT media segments and a plurality of OTA media segments, and wherein the plurality of OTA media segments and the plurality of OTT media segments correspond to a same time period of a media program;
transmit the plurality of OTA media segments to a broadcast node; and
transmit, to the media client device, one or more OTT media segments of the plurality of OTT media segments over the OTT communications channel, wherein the media client switches from playing the media program from one or more OTT media segments of the plurality of OTT media segments to playing the media program from the one or more OTA media segments of the plurality of OTA media segments.

16. The system of claim 15, wherein the plurality of OTA media segments encapsulate a representation of the media program and the plurality of OTT media segments encapsulate another representation of the media program, wherein the representation of the media program encapsulated by the plurality of OTA media segments has a higher resolution or a higher bitrate than the another representation of the media program encapsulated by the plurality of OTT media segments.

17. The system of claim 15, wherein the plurality of OTA media segments and the plurality of OTT media segments encapsulate dynamic adaptive streaming over hypertext transfer protocol (HTTP) (DASH) protocol segments corresponding to the media program.

18. The system of claim 15, wherein the identifier is a global service identifier (GSID) of the OTA communications channel.

19. The system of claim 15, wherein the plurality of OTA media segments are encapsulated within one or more ATSC 3.0 broadcast frames for transmission over the OTA communications channel.

20. The system of claim 15.
wherein the OTA MPD comprises information corresponding to one or more OTT representations and information corresponding to one or more OTA representations, and
wherein the broadcast node is an Advanced Television Systems Committee (ATSC) 3.0 broadcast node.
